(19) United States
(12) Patent Application Publication
(10) Pub. No.: US 2025/0142527 A1
(43) Pub. Date: May 1, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/691,281

(22) PCT Filed: Sep. 14, 2021
(86) PCT No.: PCT/CN2021/118361

§ 371 Date: Mar. 12, 2024

(51) Int. Cl. H04W 68/00; H04W 76/27

(52) U.S. Cl. CPC H04W 68/00; H04W 76/27

(57) ABSTRACT

Embodiments of the present disclosure relate to methods, devices and computer readable media for communication. A first network device receives a first paging message from a second network device in a RAN, the first paging message comprising information on a MT-SDT for a terminal device, and determines, based on the information, whether the MT-SDT is performed for the terminal device. If the MT-SDT is performed for the terminal device, the first network device transmits, to the terminal device, a second paging message comprising an indication indicating that the MT-SDT is performed for the terminal device. In this way, the MT-SDT procedure can be triggered.

### TECHNICAL FIELD

Embodiments of the present disclosure generally relate to the field of telecommunication, and in particular, to methods, devices and computer storage media of communication for small data transmission (SDT).

### BACKGROUND

Typically, a terminal device in an inactive state may still have small and infrequent data traffic to be transmitted. Until the third generation partnership project (3GPP) Release 16, the inactive state cannot support data transmission, and the terminal device has to resume connection (i.e., enter a connected state) for any downlink and uplink data. This will result in unnecessary power consumption and signaling overhead.

In this event, 3GPP Release 17 has approved small data transmission (SDT) in the inactive state. SDT is a procedure allowing data transmission while remaining in an inactive state (i.e. without transitioning to a connected state). Thereby, the signaling overhead can be reduced. In 3GPP Release 17, only mobile originated SDT (MO-SDT) is specified. MO-SDT means that the triggering of SDT in inactive state is due to arriving of uplink (UL) data. In 3GPP Release 18, one of the potential enhancement aspects is mobile terminated SDT (MT-SDT). MT-SDT means that the triggering of SDT in inactive state is due to arriving of downlink (DL) data. Up to now, MT-SDT related techniques are incomplete and to be further developed.

### SUMMARY

In general, embodiments of the present disclosure provide methods, devices and computer storage media of communication.

In a first aspect, there is provided a method of communication. The method comprises: receiving, at a first network device, a first paging message from a second network device in a radio access network, the first paging message comprising information on a MT-SDT for a terminal device; determining, based on the information, whether the MT-SDT is performed for the terminal device; and in accordance with a determination that the MT-SDT is performed for the terminal device, transmitting, to the terminal device, a second paging message comprising a first indication indicating that the MT-SDT is performed for the terminal device.

In a second aspect, there is provided a method of communication. The method comprises: transmitting, at a second network device in a radio access network, a first paging message to a first network device, the first paging message comprising information on a MT-SDT for a terminal device.

In a third aspect, there is provided a method of communication. The method comprises: receiving, at a terminal device, a radio resource control (RRC) release message from a network device, the RRC release message comprising a configuration of a first set of radio bearers, the first set of radio bearers supporting a MT-SDT; storing the configuration; and entering into an inactive state.

In a fourth aspect, there is provided a method of communication. The method comprises: transmitting, at a network device, a RRC release message to a terminal device, the RRC release message comprising a configuration of a first set of radio bearers, the first set of radio bearers supporting a MT-SDT.

In a fifth aspect, there is provided a method of communication. The method comprises: receiving, at a network device and from a terminal device, an indication indicating arriving of uplink data from a second set of radio bearers, the second set of radio bearers supporting a MO-SDT and the second set of radio bearers being suspended.

In a sixth aspect, there is provided a terminal device. The terminal device comprises a processor and a memory coupled to the processor. The memory stores instructions that when executed by the processor, cause the terminal device to perform the method according to the third aspect of the present disclosure.

In a seventh aspect, there is provided a network device. The network device comprises a processor and a memory coupled to the processor. The memory stores instructions that when executed by the processor, cause the network device to perform the method according to the first, second, fourth or fifth aspect of the present disclosure.

In an eighth aspect, there is provided a computer readable medium having instructions stored thereon. The instructions, when executed on at least one processor, cause the at least one processor to perform the method according to the third aspect of the present disclosure.

In a ninth aspect, there is provided a computer readable medium having instructions stored thereon. The instructions, when executed on at least one processor, cause the at least one processor to perform the method according to the first, second, fourth or fifth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a user plane (UP) protocol stack in which some embodiments of the present disclosure can be implemented;

FIG. 1C illustrates a schematic diagram of a control plane (CP) protocol stack in which some embodiments of the present disclosure can be implemented;

FIG. 2A illustrates a schematic diagram illustrating a radio access network (RAN) paging procedure in which some embodiments of the present disclosure can be implemented;

FIG. 2B illustrates a schematic diagram illustrating a MO-SDT procedure for one-shot in which some embodiments of the present disclosure can be implemented;

FIG. 2C illustrates a schematic diagram illustrating a MO-SDT procedure comprising initial transmission and subsequent transmission in which some embodiments of the present disclosure can be implemented;

FIG. 3 illustrates a schematic diagram illustrating a process for communication during a MT-SDT procedure according to embodiments of the present disclosure;

FIG. 4 illustrates a schematic diagram illustrating another process for communication during a MT-SDT procedure according to embodiments of the present disclosure;

FIG. 5A illustrates a schematic diagram illustrating another process for communication during a MT-SDT procedure according to embodiments of the present disclosure;

FIG. 5B illustrates a schematic diagram illustrating another process for communication during a MT-SDT procedure according to embodiments of the present disclosure;

FIG. 6 illustrates an example method of communication implemented at a network device serving a terminal device in accordance with some embodiments of the present disclosure;

FIG. 7 illustrates an example method of communication implemented at a network device as the last serving network device for a terminal device in accordance with some embodiments of the present disclosure;

FIG. 8 illustrates an example method of communication implemented at a terminal device in accordance with some embodiments of the present disclosure;

FIG. 9 illustrates an example method of communication implemented at a network device as the last serving network device for a terminal device in accordance with some embodiments of the present disclosure;

FIG. 10 illustrates another example method of communication implemented at a network device serving a terminal device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

Currently, there are various applications that involve exchange of small and infrequency data. For example, in some applications of mobile devices, SDT may involve traffic from Instant Messaging (IM) services, heart-beat or keep-alive traffic, for example, from IM or email clients and other services, push notifications in various applications, traffic from wearables (including, for example, periodic positioning information), and/or the like. In some applications of non-mobile devices, SDT may involve sensor data (e.g., temperature, pressure readings transmitted periodically or in an event-triggered manner in an IoT network), metering and alerting information sent from smart meters, and/or the like.

As mentioned above, MT-SDT related techniques are incomplete and to be further developed. For example, in case of multiple-gNB scenarios, which gNB decides on whether to trigger the MT-SDT. As another example, which one or more radio bearers support MT-SDT.

In view of this, embodiments of the present disclosure provide solutions of communication for a MT-SDT to overcome the above and other potential issues. Principles and implementations of the present disclosure will be described in detail below with reference to the figures.

### Example of Communication Environment

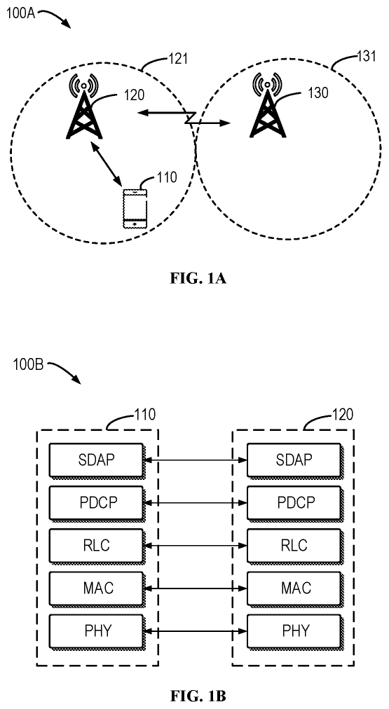

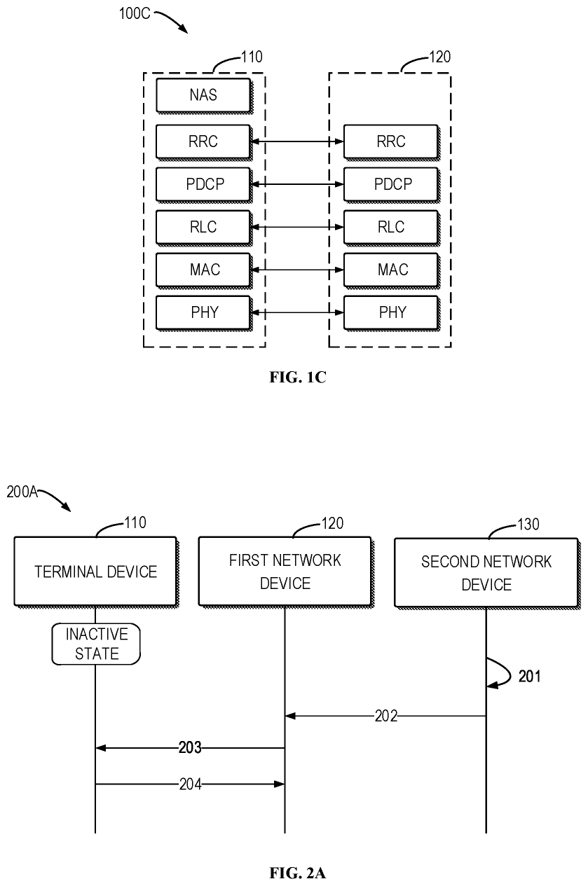

FIG. 1A illustrates a schematic diagram of an example communication network 100 in which some embodiments of the present disclosure can be implemented. As shown in FIG. 1A, the communication network 100 may include a terminal device 110 and a plurality of network devices. For illustration, a first network device 120 and a second network device 130 are shown as the plurality of network devices. The first and second network devices 120 and 130 provide respective cells 121 and 131 to serve a terminal device. In the example of FIG. 1A, the terminal device 110 is located within the cell 121 of the first network device 120, and the terminal device 110 may communicate with the first network device 120. The cell 121 may be referred to as a serving cell of the terminal device 110.

In the context of the present application, assuming that the second network device 130 is the last serving network device for the terminal device 110. In other words, the second network device 130 instructs the terminal device 110 to enter into an inactive state. The last serving network device keeps the context of the terminal device 110 and associated NG connection with the serving authentication management function (AMF) and user plane function (UPF) in the core network (CN) (not shown). The first network device 120 is a neighboring network device of the second network device 130, and cell 121 of the first network device 120 is included in a RAN-based notification area (RNA) of the terminal device 110. The RNA of the terminal device 110 is configured by the last serving network device, i.e. the second network device 130. The RNA may cover a single cell or multiple cells, and may be contained within a CN registration area, and Xn connectivity may be available within the RNA. The terminal device 110 may move within the RNA without notifying the network.

It is to be understood that the number of devices in FIG. 1A is given for the purpose of illustration without suggesting any limitations to the present disclosure. The communication network 100 may include any suitable number of network devices and/or terminal devices adapted for implementing implementations of the present disclosure. Further, each of the first and second network devices 120 and 130 may provide more cells for the terminal device 110.

As shown in FIG. 1A, the terminal device 110 may communicate with the first and second network devices 120 and 130 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Communication in a direction from the terminal device 110 towards the first or second network devices 120 or 130 is referred to as UL communication, while communication in a reverse direction from the first or second network devices 120 or 130 towards the terminal device 110 is referred to as DL communication. The terminal device 110 can move amongst the cells of the first or second network devices 120 or 130 and possibly other network devices. In UL communication, the terminal device 110 may transmit UL data and control information to the first or second network devices 120 or 130 via a UL channel. In DL communication, the first or second network devices 120 or 130 may transmit DL data and control information to the terminal device 110 via a DL channel.

The communications in the communication network 100 can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure.

As shown in FIG. 1B, in the UP, each of the terminal device 110, the first network device 120 and the second network device 130 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110, the first network device 120 and the second network device 130 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. In the context of the present disclosure, a DRB may be configured as supporting a transmission in an inactive state (i.e., supporting SDT). Of course, a DRB may also be configured as not supporting a transmission in an inactive state. A SRB may be configured as supporting a transmission in an inactive state. Of course, a SRB may also be configured as not supporting a transmission in an inactive state.

Three types of SRBs are defined in a RRC layer, i.e., SRB0, SRB1 and SRB2. SRB0 uses a CCCH for RRC connection establishment or re-establishment. SRB1 uses a DCCH and is established when RRC connection is established. SRB2 uses a DCCH and is established during RRC reconfiguration and after initial security activation.

In addition, a protocol data unit (PDU) session may be established at the NAS layer of the terminal device 110 to transmit data to CN or receive data from CN. A PDU session may correspond to a SDAP entity, and may comprise a plurality of quality of service (QOS) flows. In the context of the present disclosure, a QoS flow may be configured as supporting a transmission in an inactive state. Of course, a QoS flow may also be configured as not supporting a transmission in an inactive state.

In some scenarios, if the second network device 130 as the last serving network device receives DL data from the UPF or DL signaling associated with the terminal device 110 from the AMF (except the UE context release command message) while the terminal device 110 is in an inactive state, the second network device 130 may page in the cells corresponding to the RAN-based notification area (RNA). This procedure may be called as RAN paging. During the RAN paging, the second network device 130 may transmit XnAP RAN paging message to one or more neighbor network devices if the RNA includes cells of the one or more neighbor network devices.

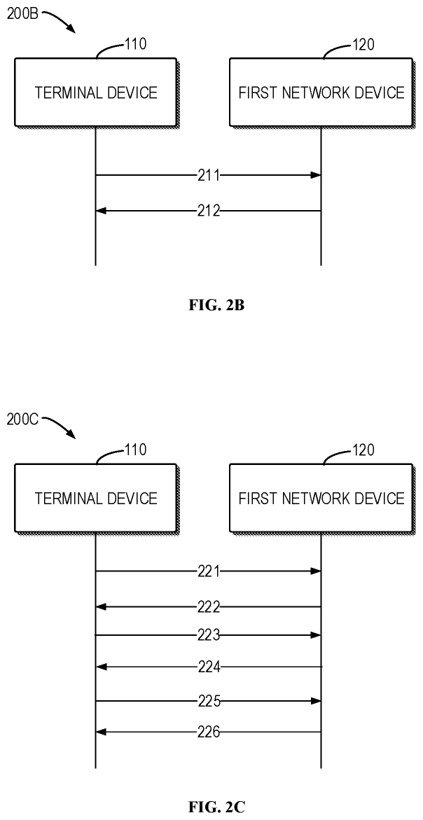

FIG. 2A illustrates a schematic diagram illustrating a RAN paging procedure 200A in which some embodiments of the present disclosure can be implemented. For the purpose of discussion, the process 200A will be described with reference to FIG. 1. The process 200A may involve the terminal device 110, the first network device 120 and the second network device 130 as illustrated in FIG. 1.

As shown in FIG. 2A, the terminal device 110 is in an inactive state. The second network device 130 may determine 201 whether a RAN paging trigger event occurs. For example, if the second network device 130 receives DL data from the UPF or DL signaling associated with the terminal device 110 from the AMF (except the UE context release command message), the second network device 130 may determine that the RAN paging trigger event occurs. Of course, the RAN paging trigger event is not limited to this example, and may be in any other suitable forms.

If determining that the RAN paging trigger event occurs, the second network device 130 may page in the cells corresponding to the RNA. For convenience, assuming that the first network device 120 is in the cells corresponding to the RNA, and the following description is made by taking the first network device 120 as an example. In this case, the second network device 130 may transmit 202 a XnAP RAN paging message to the first network device 120 and other network devices in the RNA.

Upon receipt of the XnAP RAN paging message, the first network device 120 may transmit 203 a paging message to the terminal device 110. In some embodiments, the paging message may comprise an inactive radio network temporary identifier (I-RNTI). Of course, the paging message may also comprise any other suitable information. If the terminal device 110 has been successfully reached, the terminal device 110 may attempt to resume 204 from the inactive state. So far, a RAN paging procedure is done. It is to be understood that the RAN paging procedure 200A may comprise more or less steps, and is not limited to the above example.

In some scenarios, when the terminal device 110 in an inactive state has small and infrequency data traffic to be transmitted, the terminal device 110 may initiate a SDT procedure, i.e., MO-SDT. As mentioned above, SDT is a procedure allowing data transmission while remaining in an inactive state (i.e. without transitioning to a connected state). In some embodiments, SDT is enabled on a radio bearer basis and is initiated by a terminal device only if less than a configured amount of UL data awaits transmission across all radio bearers for which SDT is enabled and measured reference signal receiving power (RSRP) in the cell is above a configured threshold.

FIG. 2B illustrates a schematic diagram illustrating a MO-SDT procedure 200B for one-shot in which some embodiments of the present disclosure can be implemented. For the purpose of discussion, the process 200B will be described with reference to FIG. 1. The process 200B may involve the terminal device 110 and the first network device 120 as illustrated in FIG. 1. This is merely an example, and it is to be understood that the process 200B may also be performed between the terminal device 110 and the second network device 130.

As shown in FIG. 2B, the terminal device 110 in an inactive state may transmit 211, to the first network device 120, a RRC resume request with UL data associated with the data traffic. For example, the terminal device 110 may transmit the RRC resume request with UL data in Msg A of a 2-step RACH procedure or in Msg3 of a 4-step RACH procedure. Of course, the terminal device 110 may also transmit the RRC resume request with UL data in a configured grant (CG) resource. Upon receipt of the RRC resume request and the UL data, the first network device 120 may transmit 212 a RRC release message with DL data corresponding to the UL data to the terminal device 110. For example, the first network device 120 may transmit the RRC release message with the DL data in Msg B of a 2-step RACH procedure or in Msg4 of a 4-step RACH procedure. Or the first network device 120 may transmit the RRC release message with DL data as response of the transmission at the CG resource. So far, the SDT procedure 200B ends.

FIG. 2C illustrates a schematic diagram illustrating a MO-SDT procedure 200C comprising initial transmission and subsequent transmission in which some embodiments of the present disclosure can be implemented. As shown in FIG. 2C, the terminal device 110 in an inactive state may transmit 221, to the first network device 120, a RRC resume request with UL data and a BSR. For example, the terminal device 110 may transmit the RRC resume request with the UL data and the BSR in Msg A of a 2-step RACH procedure or in Msg3 of a 4-step RACH procedure. Of course, the terminal device 110 may also transmit the RRC resume request with UL data in a configured grant (CG) resource. The RRC resume request may comprise a resume cause. Upon receipt of the RRC resume request with the UL data and the BSR, the first network device 120 may transmit 222 an indication of subsequent transmission to the terminal device 110. For example, the first network device 120 may transmit an explicit RRC message indicating the subsequent transmission. As another example, the first network device 120 may transmit an UL grant for further transmission so as to implicitly indicating the subsequent transmission. In some embodiments, the first network device 120 may transmit DL data with the indication to the terminal device 110. So far, the initial transmission is done.

Based on the indication, the terminal device 110 may transmit 223 further UL data and BSR to the first network device 120, for example, based on a dynamic grant or configured grant. Then the first network device 120 may transmit 224 an UL grant for dynamic grant to the terminal device 110. In some embodiments, the first network device 120 may transmit DL data with the UL grant to the terminal device 110. Based on the UL grant from the first network device 120, the terminal device 110 may transmit 225 remaining UL data to the first network device 120. Accordingly, the first network device 120 may transmit 226 RRC release message to the terminal device 110. So far, subsequent transmission is done. That is, the SDT procedure 200C ends. It is to be understood that the SDT procedure 200C may comprise more or less steps in the subsequent transmission.

### Example Implementation of MT-SDT

Embodiments of the present disclosure provide solutions of communication for a MT-SDT. In one aspect, a solution for triggering a MT-SDT is provided. In another aspect, a solution for configuring radio bearers for a MT-SDT is provided. In still another aspect, a solution for handling a MO-SDT during a MT-SDT is provided. The detailed description will be given below in connection with Embodiments 1 to 3.

### Embodiment 1

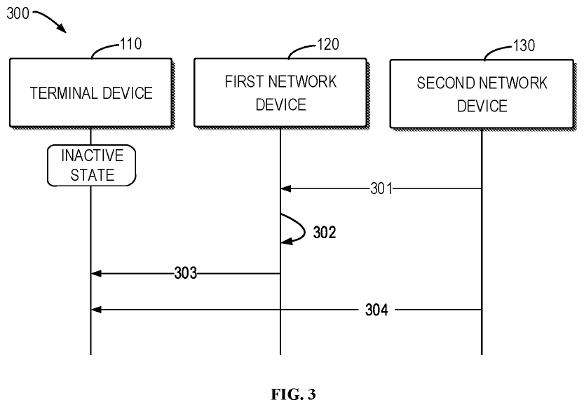

In this embodiment, a solution for triggering a MT-SDT is provided. In some embodiments, the triggering of the MT-SDT may be done by the last serving network device for a terminal device. In some embodiments, the triggering of the MT-SDT may be done by a neighboring network device of the last serving network device for a terminal device. In other words, the triggering of the MT-SDT may be done by any of network devices within the RNA of a terminal device. The solution will be described in detail with reference to FIG. 3.

FIG. 3 illustrates a schematic diagram illustrating a process 300 for communication during a MT-SDT procedure according to embodiments of the present disclosure. For the purpose of discussion, the process 300 will be described with reference to FIG. 1. The process 300 may involve the terminal device 110, the first network device 120 and the second network device 130 as illustrated in FIG. 1. Assuming that the first network device 120 is the current serving network device for the terminal device 110 and the second network device 130 is the last serving network device for the terminal device 110, and that the terminal device 110 has entered into an inactive state under instruction of the last serving network device.

As shown in FIG. 3, when the second network device 130 determines that a RAN paging trigger event occurs, the second network device 130 may transmit 301 a RAN paging message (for convenience, also referred to as a first paging message herein) to the first network device 120 and other network devices (not shown) in the cells corresponding to the RNA. According to embodiments of the present disclosure, the RAN paging message comprises information on MT-SDT for the terminal device 110. In this way, the triggering of the MT-SDT may be implemented.

In some embodiments, the second network device 130 may determine whether a MT-SDT is performed for the terminal device 110. In some embodiments, the second network device 130 may determine whether the MT-SDT is performed for the terminal device 110 based on at least one of a radio bearer associated with DL data, a size of the DL data, or a capability of the terminal device 110. In some embodiments, the second network device 130 may determine whether the MT-SDT is performed for the terminal device 110 based on at least one of the following: whether the terminal device 110 supports the MT-SDT; whether the DL data is from a radio bearer configured with SDT; or whether a size of the DL data is less than a threshold size. For example, if the terminal device 110 supports MT-SDT, all the DL data are from one or more radio bearers configured with SDT, and the size of the DL data is less than the threshold size, the second network device 130 may determine that the MT-SDT is performed for the terminal device 110. That is, the second network device 130 can trigger the MT-SDT. It is to be understood that this is merely an example, the second network device 130 may adopt any other suitable ways to determine whether the MT-SDT is performed for the terminal device 110.

In some embodiments, upon determination whether the MT-SDT is performed for the terminal device 110, the second network device 130 may generate, as the information in the RAN paging message, an indication (for convenience, also referred to as a second indication herein) indicating whether the MT-SDT is performed for the terminal device 110. In this way, the triggering of the MT-SDT is decided by the last serving network device. As the last serving network device has all the information needed for decision of the MT-SDT, it is efficient and easy for the last serving network device to decide on whether to perform the MT-SDT.

In some embodiments, the second network device 120 may cause an information element (IE) of MT-SDT indication to be comprised in the RAN paging message, for example, as shown in Table 1 below.

TABLE 1
An Example of IEs in a RAN Paging Message

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| CHOICE UE Identity Index | M | | | | YES | reject |
| Value | | | | | | |
| >Length-10 | | | | | | |
| >>Index Length-10 | M | | BIT STRING | Coded as | — | |
| | | | (SIZE(10)) | specified in TS | | |
| | | | | 38.304 [33] and | | |
| | | | | TS 36.304 [34]. | | |
| UE RAN Paging Identity | M | | 9.2.3.43 | | YES | ignore |
| Paging DRX | M | | 9.2.3.66 | Includes the | YES | ignore |
| | | | | RAN paging | | |
| | | | | cycle as defined | | |
| | | | | in TS 36.304 | | |
| | | | | [34] and 38.304 | | |
| | | | | [33] | | |
| RAN Paging Area | M | | 9.2.3.38 | | YES | reject |
| Paging Priority | O | | 9.2.3.44 | | YES | ignore |
| Assistance Data for RAN | O | | 9.2.3.41 | | YES | ignore |
| Paging | | | | | | |
| UE Radio Capability for | O | | 9.2.3.91 | | YES | ignore |
| Paging | | | | | | |
| Extended UE Identity Index | O | | 9.2.3.141 | Coded as | YES | ignore |
| Value | | | | specified in TS | | |
| | | | | 36.304 [34]. | | |
| Paging eDRX Information | O | | 9.2.3.142 | | YES | ignore |
| UE specific DRX | O | | 9.2.3.143 | Includes the UE | YES | ignore |
| | | | | specific paging | | |
| | | | | cycle as defined | | |
| | | | | in TS 36.304 | | |
| | | | | [34] and 38.304 | | |
| | | | | [33] | | |
| MT-SDT indication | O | | | Indicates | | |
| | | | | whether | | |
| | | | | MT-SDT shall | | |
| | | | | apply. | | |

The type of MT-SDT indication IE may be ENUMERATED (true, . . . ). It is to be understood that Table 1 is merely an example, and any other suitable forms are also feasible.

In some alternative embodiments, the second network device 130 may transmit, as the information, assistant information for facilitating the first network device 120 to decide the trigger of the MT-SDT. In some embodiments, the information or assistant information may comprise at least one of the following: a size of downlink data, a capability of the terminal device 110 for a SDT or a context of the terminal device 110 regarding a configuration for SDT. It is to be understood that the information may also comprise any other suitable items, and the present disclosure does not limit this aspect.

In some embodiments, the second network device 120 may cause an IE of assistant information to be comprised in the RAN paging message. For example, IEs of DL data size, UE capability for SDT and UE configuration for SDT are shown in Table 2 below.

TABLE 2
Another Example of IEs in a RAN Paging Message

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| CHOICE UE Identity Index | M | | | | YES | reject |
| Value | | | | | | |
| >Length-10 | | | | | | |
| >>Index Length-10 | M | | BIT STRING | Coded as | — | |
| | | | (SIZE(10)) | specified in | | |
| | | | | TS 38.304 | | |
| | | | | [33] and TS | | |
| | | | | 36.304 [34]. | | |
| UE RAN Paging Identity | M | | 9.2.3.43 | | YES | ignore |
| Paging DRX | M | | 9.2.3.66 | Includes the | YES | ignore |
| | | | | RAN paging | | |
| | | | | cycle as | | |
| | | | | defined in TS | | |
| | | | | 36.304 [34] | | |
| | | | | and 38.304 | | |
| | | | | [33]. | | |
| RAN Paging Area | M | | 9.2.3.38 | | YES | reject |
| Paging Priority | O | | 9.2.3.44 | | YES | ignore |
| Assistance Data for RAN | O | | 9.2.3.41 | | YES | ignore |
| Paging | | | | | | |
| UE Radio Capability for | O | | 9.2.3.91 | | YES | ignore |
| Paging | | | | | | |
| Extended UE Identity Index | O | | 9.2.3.141 | Coded as | YES | ignore |
| Value | | | | specified in | | |
| | | | | TS 36.304 | | |
| | | | | [34]. | | |
| Paging eDRX Information | O | | 9.2.3.142 | | YES | ignore |
| UE specific DRX | O | | 9.2.3.143 | Includes the | YES | ignore |
| | | | | UE specific | | |
| | | | | paging cycle | | |
| | | | | as defined in | | |
| | | | | TS 36.304 | | |
| | | | | [34] and | | |
| | | | | 38.304 [33]. | | |
| DL data size | O | | | Indicates the | | |
| | | | | size of the | | |
| | | | | DL data. | | |
| UE capability for SDT | O | | | | | |
| UE configuration for SDT | O | | | For example: | | |
| | | | | threshold, | | |
| | | | | which radio | | |
| | | | | bearers | | |
| | | | | support | | |
| | | | | MT-SDT | | |

The type of DL data size IE may be INTEGER OR BIT STRING. The type of UE capability for SDT IE may be OCTET STRING. The type of UE configuration for SDT IE may be OCTET STRING. It is to be understood that Table 2 is merely an example, and any other suitable forms are also feasible. In this way, each network device can decide on whether to trigger the MT-SDT and thus its implementation is flexible.

Upon receipt of the RAN paging message, the first network device 120 may determine 303 whether the MT-SDT is performed for the terminal device 110 based on the information. In some embodiments where the information comprises the indication indicating that the MT-SDT is performed for the terminal device 110, the first network device 120 may follow the decision of the second network device 130 and determine that the MT-SDT is performed for the terminal device 110.

In some alternative embodiments where the information comprises the indication indicating that the MT-SDT is performed for the terminal device 110, the first network device 120 may further determine whether the MT-SDT is performed for the terminal device 110 by itself. For example, the first network device 120 may determine whether the MT-SDT is performed for the terminal device 110 based on whether the first network device 110 supports the MT-SDT. As another example, the first network device 120 may determine whether the MT-SDT is performed for the terminal device 110 based on whether a load condition for the first network device 110 meets a threshold condition. Of course, the first network device 120 may also adopt any other suitable ways to determine whether the MT-SDT is performed for the terminal device 110, and the present disclosure does not limit this aspect.

In some embodiments where the information comprises the assistant information for facilitating the first network device 120 to decide the trigger of the MT-SDT, the first network device 120 may determine whether the MT-SDT is performed for the terminal device 110 based on the assistant information. In some embodiments, the first network device 120 may determine whether the MT-SDT is performed for the terminal device 110 based on whether the first network device 120 supports the MT-SDT. In some embodiments, the first network device 120 may determine whether the MT-SDT is performed for the terminal device 110 based on whether the terminal device 110 supports the MT-SDT. In some embodiments, the first network device 120 may determine whether the MT-SDT is performed for the terminal device 110 based on whether a load condition for the first network device 120 meets a threshold condition. In some embodiments, the first network device 120 may determine whether the MT-SDT is performed for the terminal device 110 based on whether the size of DL data is less than a threshold size. Of course, the first network device 120 may also adopt any other suitable ways to determine whether the MT-SDT is performed for the terminal device 110, and the present disclosure does not limit this aspect.

If determining that the MT-SDT is performed for the terminal device 110, the first network device 120 may transmit 303 a paging message (for convenience, also referred to as a second paging message herein) to page the terminal device 110. The second paging message may comprise an indication (for convenience, also referred to as a first indication herein) indicating that the MT-SDT is performed for the terminal device 110.

In some embodiments, upon determination that the MT-SDT is performed for the terminal device 110, the second network device 130 may also transmit 304 a paging message (for convenience, also referred to as a third paging message herein) to page the terminal device 110. The third paging message may also comprise an indication (for convenience, also referred to as a third indication herein) indicating that the MT-SDT is performed for the terminal device 110.

In this way, the MT-SDT may be triggered in a flexible way.

### Embodiment 2

In this embodiment, a solution for configuring one or more radio bearers for a MT-SDT is provided.

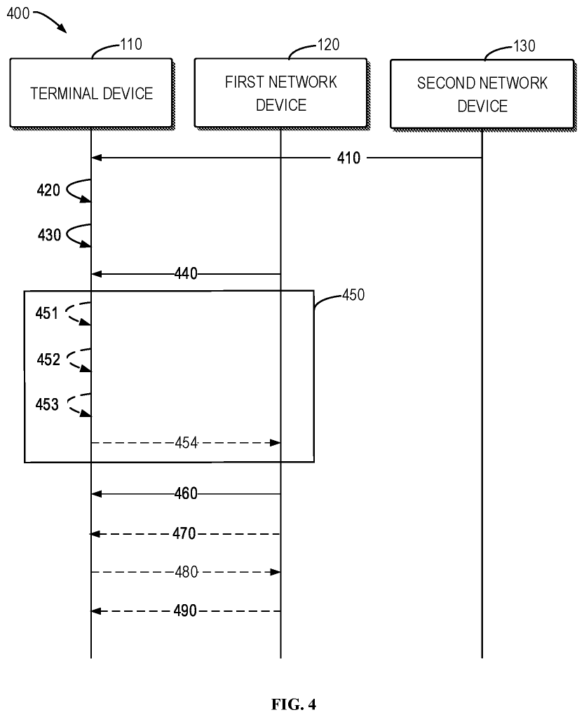

For MO-SDT, which radio bearer can support SDT may be configured by the network side. Considering the traffic characteristic may be different for each radio bearer, supporting the same radio bearers for MO-SDT and MT-SDT may be not suitable. For example, for some radio bearers, they may have big UL packet size but small DL packets size. As another example, for some radio bearers, they may have big DL packet size but small UL packet size. In view of this, embodiments of the present disclosure propose that which radio bearer supporting MO-SDT and which radio bearer supporting MT-SDT are separately configured. This will be described in detail with reference to FIG. 4.

FIG. 4 illustrates a schematic diagram illustrating another process 400 for communication during a MT-SDT procedure according to embodiments of the present disclosure. For the purpose of discussion, the process 400 will be described with reference to FIG. 1. The process 400 may involve the terminal device 110, the first network device 120 and the second network device 130 as illustrated in FIG. 1. Assuming that the first network device 120 is the current serving network device for the terminal device 110 and the second network device 130 is the last serving network device for the terminal device 110.

As shown in FIG. 4, the second network device 130 may transmit 410 a RRC release message to the terminal device 110 to instruct the terminal device 110 to enter into an inactive state. For example, the second network device 130 may configure which radio bearer supports the MT-SDT in RRC release message with suspendConfig. In some embodiments, the RRC release message may comprise a configuration of a set of radio bearers (for convenience, also referred to as a first set of radio bearers herein), and the set of radio bearers supports a MT-SDT. In this way, a radio bearer supporting a MT-SDT is configured. In some embodiments, the first set of radio bearers may be different from a set of radio bearers (for convenience, also referred to as a second set of radio bearers herein) supporting a MO-SDT. In some alternative embodiments, the first set of radio bearers may be the same as the second set of radio bearers. In some alternative embodiments, the set of radio bearers configured as supporting MO-SDT may be treated as also supporting MT-SDT. In some embodiments, the first set of radio bearers may comprise SRB and DRB. Of course, the first set of radio bearers may adopt any other suitable forms.

Upon receipt of the RRC release message, the terminal device 110 may store 420 the configuration of the first set of radio bearers, and enter 430 into an inactive state.

The terminal device 110 in the inactive state may receive 440 a paging message from a network device (for convenience, taking the first network device 120 as an example, but the last serving network device or any of neighboring network devices is possible), the paging message comprising an indication indicating that the MT-SDT is performed for the terminal device 110. As a result, the terminal device 110 may initiate 450 a RRC resume procedure for the MT-SDT.

During the initiation of the RRC resume procedure, in some embodiments, the terminal device 110 may resume 451 the first set of radio bearers supporting the MT-SDT. In some embodiments, the terminal device 110 may perform 452 a PDCP reestablishment for the PDCP entities of the first set of radio bearers, and perform 453 a RLC reestablishment for the RLC entities of the first set of radio bearers. In some embodiments, the terminal device 110 may transmit 454 a RRC resume request message to the first network device 120. In some embodiments, the RRC resume request message may comprise a resume cause set as MT-SDT.

In some embodiments, the terminal device 110 may determine a set of random access resources and a set of random access parameters configured for non-SDT, and initiate the RRC resume procedure with the set of random access resources and the set of random access parameters. The set of random access resources configured for non-SDT means that the set of random access resources is not dedicatedly reserved for SDT. The set of random access parameters configured for non-SDT means that the set of random access parameters is not dedicatedly configured for SDT.

In some alternative embodiments, the terminal device 110 may determine whether there is UL data buffered for one or more radio bearers in the first set of radio bearers. If there is the UL data, the terminal device 110 may determine a set of random access resources and a set of random access parameters configured for a SDT. If there is no UL data buffered for the first set of radio bearers, the terminal device 110 may determine a set of random access resources and a set of random access parameters configured for non-SDT, and initiate the RRC resume procedure with the determined set of random access resources and the determined set of random access parameters.

In some embodiments, the terminal devices may determine the set of random access resources by determining resources for a preamble and a random access occasion. In some embodiments, the set of random access parameters may comprise rsrp-ThresholdSSB, msgA-RSRP-ThresholdSSB, preambleReceivedTargetPower/gA-PreambleReceivedTargetPower, powerRampingStep/msgA-PreamblePowerRampingStep, msg3-DeltaPreamble/msgA-DeltaPreamble, msg3-DeltaPreamble/msgA-DeltaPreamble, messagePowerOffsetGroupB or the like. It should be noted that any other suitable parameters are also feasible.

In some embodiments, the terminal device 110 may transmit, to the first network device 120, the RRC resume request message for MT-SDT without UL data. Upon receipt of the RRC resume request message, the first network device 120 may transmit 460 a RRC release message with DL data to the terminal device 110. In this way, a MT-SDT procedure may be done.

In some alternative embodiments, upon receipt of the RRC resume request message, the first network device 120 may transmit 470 DL data and UL grant to the terminal device 110. Correspondingly, the terminal device 110 may transmit 480 UL data based on the UL grant. The first network device 120 may transmit 490 a RRC release message or RRC resume message to the terminal device 110. In this way, a MT-SDT procedure also may be done.

### Embodiment 3

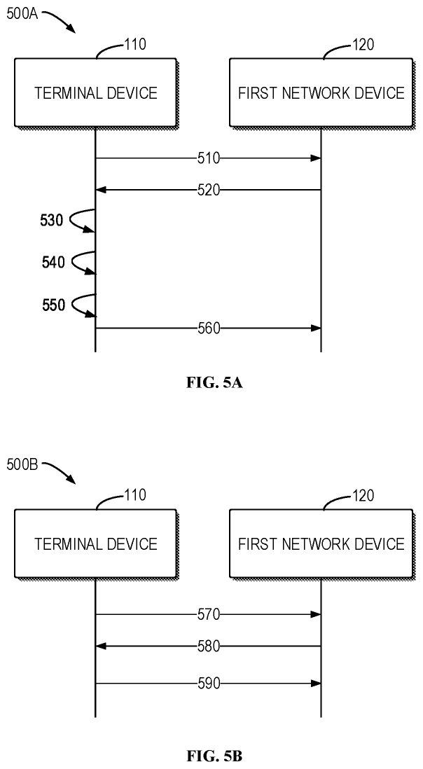

In some scenarios, after the terminal device 110 initiates the RRC resume procedure for MT-SDT, UL data may arrive at the terminal device 110 from a suspended radio bearer supporting MO-SDT. In this embodiment, solutions for handling a MO-SDT during a MT-SDT are provided for the above scenarios. The detailed description will be made with reference to FIGS. 5A and 5B.

FIG. 5A illustrates a schematic diagram illustrating another process 500A for communication during a MT-SDT procedure according to embodiments of the present disclosure. For the purpose of discussion, the process 500A will be described with reference to FIG. 1. The process 500A may involve the terminal device 110 and a network device (for convenience, taking the first network device 120 as an example) as illustrated in FIG. 1. It is to be understood that the process 500A may also be performed between the terminal device 110 and the second network device 130 as the last serving network device.

The terminal device 110 may determine, after initiating of the RRC resume procedure for MT-SDT, that UL data arrives from a second set of radio bearers supporting a MO-SDT and being suspended. In this case, as shown in FIG. 5A, the terminal device 110 may transmit 510 to the first network device 120 an indication indicating the arriving of the UL data. In some embodiments, the indication may comprise a size of the UL data. Of course, the indication may also comprise any other suitable information. In some embodiments, the terminal device 110 may transmit the indication by a RRC message using SRB1. In some embodiments, the terminal device 110 may transmit the indication by a MAC control element (MAC CE). Of course, any other suitable ways are also feasible for the transmission of the indication.

The first network device 120 may transmit 520 an indication (for convenience, also referred to as a further indication herein) indicating that the UL data is transmitted by the terminal device 110 in the inactive state. For example, the first network device 120 may transmit a RRC message to indicate the terminal device 110 to transmit the UL data under the inactive state. As another example, the first network device 120 may transmit a MAC CE to indicate the terminal device 110 to transmit the UL data under the inactive state. Of course, any other suitable ways are also feasible for the transmission of the further indication.

Upon receipt of the further indication, the terminal device 110 may resume 530 the second set of radio bearers. The terminal device 110 may also perform 540 a PDCP reestablishment for PDCP entities of the second set of radio bearers and perform 550 a RLC reestablishment for RLC entities of the second set of radio bearers. Then the terminal device 110 may transmit 560, in the inactive state, the UL data to the first network device 120.

In this way, MO-SDT is performed during the MT-SDT procedure. Another solution for handling the MO-SDT during the MT-SDT procedure will be described below with reference to FIG. 5B.

FIG. 5B illustrates a schematic diagram illustrating another process 500B for communication during a MT-SDT procedure according to embodiments of the present disclosure. For the purpose of discussion, the process 500B will be described with reference to FIG. 1. The process 500B may involve the terminal device 110 and a network device (for convenience, taking the first network device 120 as an example) as illustrated in FIG. 1. It is to be understood that the process 500A may also be performed between the terminal device 110 and the second network device 130 as the last serving network device.

The terminal device 110 may determine, after initiating of the RRC resume procedure for MT-SDT, that UL data arrives from a second set of radio bearers supporting a MO-SDT and being suspended. In this case, as shown in FIG. 5B, the terminal device 110 may transmit 570 to the first network device 120 an indication indicating the arriving of the UL data. The transmission of the indication in FIG. 5B is similar with that described in FIG. 5A and thus is not repeated here.

Upon receipt of the indication, the first network device 120 may transmit 580 a RRC resume message to the terminal device 110. In this way, the terminal device 110 enters into a connected state. Then the terminal device 110 may transmit 590 the UL data to the first network device 120 in the connected state.

So far, handling of the new arriving UL data during the MT-SDT is achieved.

### Example Implementation of Methods

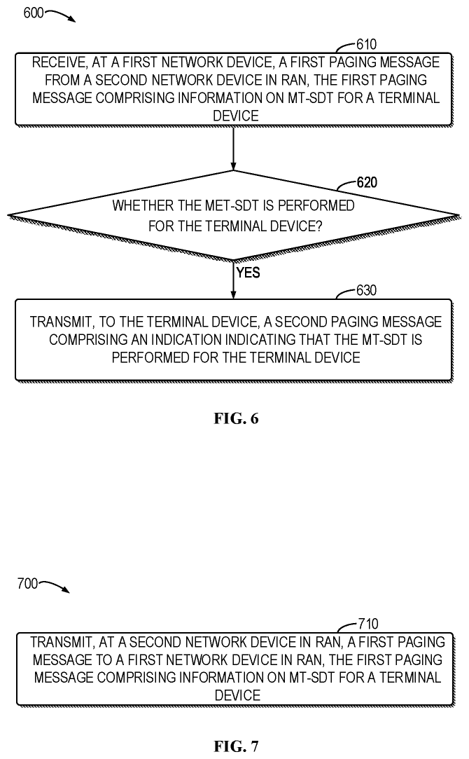

Accordingly, embodiments of the present disclosure provide methods of communication implemented at a terminal device and a network device. These methods will be described below with reference to FIGS. 6 to 10.

FIG. 6 illustrates an example method 600 of communication implemented at a network device serving a terminal device in accordance with some embodiments of the present disclosure. For example, the method 600 may be performed at the first network device 120 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the first network device 120 receives a first paging message from the second network device 130 in a RAN. The first paging message comprises information on a MT-SDT for the terminal device 110.

In some embodiments, the information may comprise a second indication indicating that the MT-SDT is performed for the terminal device 110. In some embodiments, the information may comprise assistant information for facilitating the determination on whether to perform the MT-SDT for the terminal device 110. The assistant information may comprise at least one of the following: a size of downlink data, a capability of the terminal device for a SDT, or a context of the terminal device regarding a configuration for SDT. Of course, the information may also comprise any other suitable items.

At block 620, the first network device 120 determines whether the MT-SDT is performed for the terminal device 110 based on the information. In some embodiments where the information comprises the second indication indicating that the MT-SDT is performed for the terminal device 110, the first network device 120 may determine whether the MT-SDT is performed for the terminal device based on at least one of the following: whether the first network device 120 supports the MT-SDT; or whether a load condition for the first network device 120 meets a threshold condition. It is to be understood that any other suitable ways are also feasible for the determination.

In some embodiments where the information comprises the assistant information for facilitating the determination on whether to perform the MT-SDT for the terminal device 110, the first network device 120 may determine whether the MT-SDT is performed for the terminal device 110 based on at least one of the following: whether the first network device 120 supports the MT-SDT; whether the terminal device 110 supports the MT-SDT based on at least one of the capability of the terminal device 110 for the SDT and the context of the terminal device 110 regarding the configuration for SDT; whether a load condition for the first network device 120 meets a threshold condition; or whether the size of DL data is less than a threshold size.

If determining at block 620 that the MT-SDT is performed for the terminal device 110, the process proceeds to block 630. At block 630, the first network device 120 transmits a second paging message to the terminal device 110. The second paging message comprises a first indication indicating that the MT-SDT is performed for the terminal device 110.

FIG. 7 illustrates an example method 700 of communication implemented at a network device as the last serving network device for a terminal device in accordance with some embodiments of the present disclosure. For example, the method 700 may be performed at the second network device 130 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the second network device 130 transmits a first paging message to the first network device 120 in a RAN. The first paging message comprises information on a MT-SDT for the terminal device 110.

In some embodiments, the second network device 130 may determine whether the MT-SDT is performed for the terminal device 110, and if the MT-SDT is performed for the terminal device, the second network device 130 may transmit a third paging message to the terminal device 110, the third paging message comprising a third indication indicating that the MT-SDT is performed for the terminal device 110. In some embodiments, the second network device 130 may determine whether the MT-SDT is performed for the terminal device 110 based on at least one of the following: whether the terminal device supports the MT-SDT; whether downlink data is from a radio bearer configured with SDT; or whether a size of the downlink data is less than a threshold size.

In some embodiments, the second network device 130 may generate, as the information, a second indication indicating whether the MT-SDT is performed for the terminal device 110.

In some embodiments, the second network device 130 may generate, as the information, assistant information for facilitating the determination on whether to perform the MT-SDT for the terminal device 110. The assistant information may comprise at least one of the following: a size of downlink data, a capability of the terminal device for a SDT, or a context of the terminal device regarding a configuration for SDT. Of course, the information may also comprise any other suitable items.

In this way, the MT-SDT procedure is triggered. The implementations of the methods described in FIGS. 6 and 7 substantially correspond to that described with reference to FIG. 3, and thus other details are not repeated here.

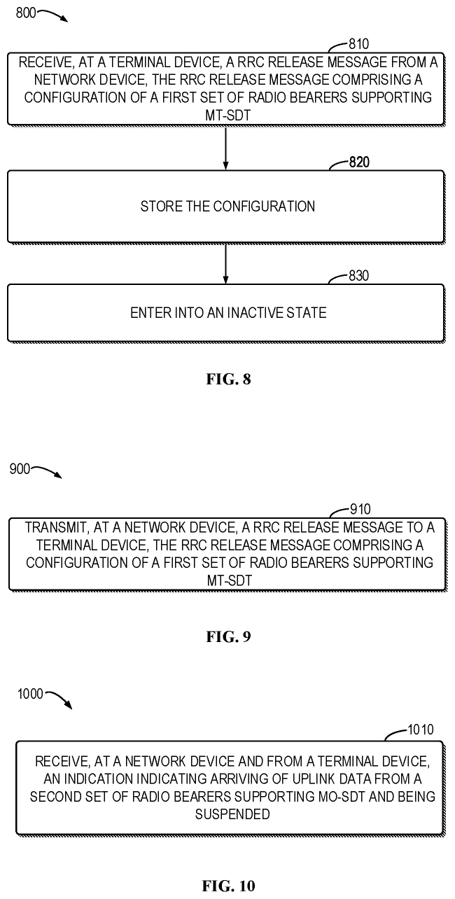

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives a RRC release message from a network device. In some embodiments, the network device may be the last serving network device, for example, the second network device 130 as illustrated in FIG. 1. The RRC release message comprises a configuration of a first set of radio bearers supporting a MT-SDT.

At block 820, the terminal device 110 stores the configuration. At block 830, the terminal device 110 enters into an inactive state.

In some embodiments, the terminal device 110 may further receive a paging message from a further network device. The paging message comprises a first indication indicating that the MT-SDT is performed for the terminal device 110. In some embodiments, the further network device may be the last serving network device. In some embodiments, the further network device may be a neighboring network device of the last serving network device. For convenience, the description is made by taking the first network device 120 as illustrated in FIG. 1 as an example.

In response to receiving the paging message from the first network device 120, the terminal device 110 may initiate a RRC resume procedure for the MT-SDT. In some embodiments, the terminal device 110 may resume the first set of radio bearers supporting the MT-SDT, perform a PDCP reestablishment for the PDCP entities of the first set of radio bearers, perform a RLC reestablishment for the RLC entities of the first set of radio bearers, and transmit a RRC resume request message to the first network device 120.

In some embodiments, the terminal device 110 may determine a set of random access resources and a set of random access parameters configured for non-SDT, and initiate the RRC resume procedure with the set of random access resources and the set of random access parameters.

In some embodiments, the terminal device 110 may determine whether there is uplink data buffered for one or more radio bearers in the first set of radio bearers. If determining that there is the uplink data, the terminal device 110 may determine a set of random access resources and a set of random access parameters configured for SDT. If determining that there is no uplink data buffered for the first set of radio bearers, the terminal device 110 may determine a set of random access resources and a set of random access parameters configured for non-SDT, and initiate the RRC resume procedure with the determined set of random access resources and the determined set of random access parameters.

In some embodiments, the terminal device 110 may determine, after the initiating, that uplink data arrives from a second set of radio bearers, the second set of radio bearers supporting a MO-SDT and the second set of radio bearers being suspended. In this case, the terminal device 110 may transmit, to the first network device 120, an indication indicating the arriving of the uplink data.

In some embodiments, the terminal device 110 may further receive, from the first network device 120, a further indication indicating that the uplink data is transmitted by the terminal device 110 in the inactive state. Upon receipt of the message, the terminal device 110 may resume the second set of radio bearers, perform PDCP reestablishment for PDCP entities of the second set of radio bearers, perform RLC reestablishment for RLC entities of the second set of radio bearers, and transmit, in the inactive state, the uplink data to the first network device 120.

In some alternative embodiments, the terminal device 110 may receive a RRC resume message from the first network device 120. In this case, the terminal device 110 may transmit, in a connected state, the uplink data to the first network device 120. In this way, a MT-SDT procedure is designed.

FIG. 9 illustrates an example method 900 of communication implemented at a network device as the last serving network device for a terminal device in accordance with some embodiments of the present disclosure. For example, the method 900 may be performed at the second network device 130 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the second network device 130 transmits a RRC release message to the terminal device 110. The RRC release message comprises a configuration of a first set of radio bearers supporting a MT-SDT. In this way, one or more radio bearers are configured for a MT-SDT.

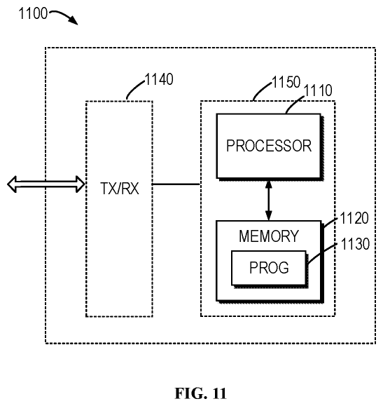

FIG. 10 illustrates an example method 1000 of communication implemented at a network device serving a terminal device in accordance with some embodiments of the present disclosure. For example, the method 1000 may be performed at the first network device 120 or the second network device 130 as shown in FIG. 1. For the purpose of discussion, in the following, the method 1000 will be described with reference to FIG. 1. For illustration, the description is made by taking the first network device 120 as an example. It is to be understood that the method 1000 may include additional blocks not shown and/or may omit some blocks as shown, and the scope of the present disclosure is not limited in this regard.

At block 1010, the first network device 120 receives an indication indicating arriving of uplink data from a second set of radio bearers. The second set of radio bearers support a MO-SDT and are suspended.

In some embodiments, the first network device 120 may transmit, to the terminal device 110, a further indication indicating that the uplink data is transmitted by the terminal device 110 in an inactive state. In these embodiments, the first network device 120 may receive the uplink data transmitted by the terminal device 110 in the inactive state.

In some embodiments, the first network device 120 may transmit a RRC resume message to the terminal device 110. In these embodiments, the first network device 120 may receive the uplink data transmitted by the terminal device 110 in a connected state.

In this way, the new arriving UL data during the MT-SDT is handled. The implementations of the methods described in FIGS. 8-10 substantially correspond to that described with reference to FIGS. 4, 5A and 5B, and thus other details are not repeated here.

### Example Implementation of Device

FIG. 11 is a simplified block diagram of a device 1100 that is suitable for implementing embodiments of the present disclosure. The device 1100 can be considered as a further example implementation of the terminal device 110 or the first network device 120 or the second network device 130 as shown in FIG. 1. Accordingly, the device 1100 can be implemented at or as at least a part of the terminal device 110 or the first network device 120 or the second network device 130.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a first network device comprises circuitry configured to: receive a first paging message from a second network device in a RAN, the first paging message comprising information on a MT-SDT, for a terminal device; determine, based on the information, whether the MT-SDT is performed for the terminal device; and in accordance with a determination that the MT-SDT is performed for the terminal device, transmit, to the terminal device, a second paging message comprising a first indication indicating that the MT-SDT is performed for the terminal device.

In some embodiments, the information may comprise a second indication indicating that the MT-SDT is performed for the terminal device. In these embodiments, the circuitry may be configured to determine that the MT-SDT is performed for the terminal device based on the second indication. In these embodiments, the circuitry may be configured to determine whether the MT-SDT is performed for the terminal device by: in response to the indication indicating that the MT-SDT is performed for the terminal device, determining whether the MT-SDT is performed for the terminal device based on at least one of the following: whether the first network device supports the MT-SDT; or whether a load condition for the first network device meets a threshold condition.

In some embodiments, the information may comprise at least one of the following: a size of downlink data, a capability of the terminal device for a small data transmission, SDT, or a context of the terminal device regarding a configuration for SDT. In these embodiments, the circuitry may be configured to determine whether the MT-SDT is performed for the terminal device by: determining whether the MT-SDT is performed for the terminal device based on at least one of the following: whether the first network device supports the MT-SDT; whether the terminal device supports the MT-SDT based on at least one of the capability of the terminal device for the SDT and the context of the terminal device regarding the configuration for SDT; whether a load condition for the first network device meets a threshold condition; or whether the size of downlink data is less than a threshold size.

In some embodiments, a second network device comprises circuitry configured to: transmit a first paging message to a first network device in a RAN, the first paging message comprising information on a MT-SDT for a terminal device.

In some embodiments, the circuitry may be further configured to: determine whether the MT-SDT is performed for the terminal device; and in accordance with a determination that the MT-SDT is performed for the terminal device, transmit a third paging message to the terminal device, the third paging message comprising a third indication indicating that the MT-SDT is performed for the terminal device. In some embodiments, the circuitry may be configured to determine whether the MT-SDT is performed for the terminal device based on at least one of the following: whether the terminal device supports the MT-SDT; whether downlink data is from a radio bearer configured with SDT; or whether a size of the downlink data is less than a threshold size.

In some embodiments, the circuitry may be further configured to generate, as the information, a second indication indicating whether the MT-SDT is performed for the terminal device.

In some embodiments, the information may comprise at least one of the following: a size of downlink data, a capability of the terminal device for a SDT, or a context of the terminal device regarding a configuration for SDT.

In some embodiments, a terminal device comprises a circuitry configured to: receive a RRC release message from a network device, the RRC release message comprising a configuration of a first set of radio bearers, the first set of radio bearers supporting a MT-SDT; store the configuration; and enter into an inactive state.

In some embodiments, the circuitry may be further configured to: in response to receiving, from a further network device, a paging message comprising a first indication indicating that the MT-SDT is performed for the terminal device, initiate a RRC resume procedure for the MT-SDT, comprising: resume the first set of radio bearers supporting the MT-SDT; perform a PDCP reestablishment for the PDCP entities of the first set of radio bearers; perform a RLC reestablishment for the RLC entities of the first set of radio bearers; and transmit a RRC resume request message to the further network device.

In some embodiments, the circuitry may be configured to initiate the RRC resume procedure for the MT-SDT by: determining a set of random access resources and a set of random access parameters configured for non-small data transmission; and initiating the RRC resume procedure with the set of random access resources and the set of random access parameters.

In some embodiments, the circuitry may be configured to initiate the RRC resume procedure for the MT-SDT by: determining whether there is uplink data buffered for one or more radio bearers in the first set of radio bearers; in accordance with a determination that there is the uplink data, determining a set of random access resources and a set of random access parameters configured for SDT; in accordance with a determination that there is no uplink data buffered for the first set of radio bearers, determining a set of random access resources and a set of random access parameters configured for non-SDT; and initiating the RRC resume procedure with the determined set of random access resources and the determined set of random access parameters.

In some embodiments, the circuitry may be further configured to: determine, after the initiating, that uplink data arrives from a second set of radio bearers, the second set of radio bearers supporting a MO-SDT, and the second set of radio bearers being suspended; and transmit, to the further network device, an indication indicating the arriving of the uplink data.

In some embodiments, the circuitry may be further configured to: receive, from the further network device, a further indication indicating that the uplink data is transmitted by the terminal device in the inactive state; resume the second set of radio bearers; perform PDCP reestablishment for PDCP entities of the second set of radio bearers; perform RLC reestablishment for RLC entities of the second set of radio bearers; and transmit, in the inactive state, the uplink data to the further network device.

In some embodiments, the circuitry may be further configured to: receive a RRC resume message from the further network device; and transmit, in a connected state, the uplink data to the further network device. In some embodiments, the further network device and the network device are the same network device.

In some embodiments, a network device comprises a circuitry configured to: transmit a RRC release message to a terminal device, the RRC release message comprising a configuration of a first set of radio bearers, the first set of radio bearers supporting a MT-SDT.

In some embodiments, a network device comprises a circuitry configured to: receive, from a terminal device, an indication indicating arriving of uplink data from a second set of radio bearers, the second set of radio bearers supporting a MO-SDT, and the second set of radio bearers being suspended.

In some embodiments, the circuitry may be further configured to: transmit, to the terminal device, a further indication indicating that the uplink data is transmitted by the terminal device in an inactive state; and receive the uplink data transmitted by the terminal device in the inactive state.

In some embodiments, the circuitry may be further configured to: transmit a RRC resume message to the terminal device; and receive the uplink data transmitted by the terminal device in a connected state.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-26. (canceled)

27. A method performed by a first network device, the method comprising:
receiving, from a second network device, a first paging message comprising first information related to a mobile-terminated small data transmission (MT-SDT); and
determining, based on the first information, whether to trigger the MT-SDT, wherein
based on a determination to trigger the MT-SDT,
the method comprises sending, to a terminal device, a second paging message comprising a first indication related to the MT-SDT.

28. The method according to claim 27, wherein
the first information comprises second indication related to the MT-SDT and a size of downlink data.

29. The method according to claim 27, wherein
the terminal device is in a Radio Resource Control (RRC) inactive state.

30. A method performed by a terminal device, the method comprising:
receiving, from a first network device, a second paging message comprising first indication related to a mobile-terminated small data transmission (MT-SDT);
initiating a procedure for the MT-SDT; and
sending, to the first network device, a Radio Resource Control (RRC) resume request message comprising a resume cause set as the MT-SDT.

31. The method according to claim 30, wherein
the second paging message is sent by the first network device based on a first paging message being received from a second network device, the first paging message comprising first information related to the MT-SDT.

32. The method according to claim 30, wherein
the first information comprises second indication related to the MT-SDT and a size of downlink data.

33. The method according to claim 30, wherein
the terminal device is in a Radio Resource Control (RRC) inactive state.

34. The method according to claim 30, wherein
the initiating a procedure for the MT-SDT comprises:
determining a set of random access resources not configured for the MT-SDT; and
initiating the procedure with the set of random access resources.

35. The method according to claim 30, wherein
the initiating a procedure for the MT-SDT comprises:
re-establishing PDCP entity for a radio bearer that is configured for the SDT; and
resuming the radio bearer that is configured for the SDT.

36. A first network device comprising:
one or more memories storing instructions; and
one or more processors configured to process the instructions to control the first network device to:
receive, from a second network device, a first paging message comprising first information related to a mobile-terminated small data transmission (MT-SDT); and
determine, based on the first information, whether to trigger the MT-SDT, wherein
based on a determination to trigger the MT-SDT,
the one or more processors are configured to process the instructions to control the first network device to send, to a terminal device, a second paging message comprising a first indication related to the MT-SDT.

37. The first network device according to claim 36, wherein
the first information comprises second indication related to the MT-SDT and a size of downlink data.

38. The first network device according to claim 36, wherein
the terminal device is in a Radio Resource Control (RRC) inactive state.

39. A terminal device comprising:
one or more memories storing instructions; and
one or more processors configured to process the instructions to control the terminal device to:
receive, from a first network device, a second paging message comprising first indication related to a mobile-terminated small data transmission (MT-SDT);
initiate a procedure for the MT-SDT; and
send, to the first network device, a Radio Resource Control (RRC) resume request message comprising a resume cause set as the MT-SDT.

40. The terminal device according to claim 39, wherein
the second paging message is sent by the first network device based on a first paging message being received from a second network device, the first paging message comprising first information related to the MT-SDT.

41. The terminal device according to claim 39, wherein
the first information comprises second indication related to the MT-SDT and a size of downlink data.

42. The terminal device according to claim 39, wherein
the terminal device is in a Radio Resource Control (RRC) inactive state.

43. The terminal device according to claim 39, wherein
the one or more processors are configured to process the instructions to control the terminal device to:
determine a set of random access resources not configured for the MT-SDT; and
initiate the procedure with the set of random access resources.

44. The terminal device according to claim 39, wherein
the one or more processors are configured to process the instructions to control the terminal device to:
re-establish PDCP entity for a radio bearer that is configured for the SDT; and
resume the radio bearer that is configured for the SDT.
